(19) United States
(12) Patent Application Publication
(10) Pub. No.: US 2016/0142607 A1
(43) Pub. Date: May 19, 2016

(54) CAMERA SYSTEM FOR VEHICLE AND OPERATION METHOD THEREOF

(71) Applicant: HYUNDAI MOBIS Co., Ltd., Yongin-si (KR)

(72) Inventor: Yeon Kyeong LEE, Yongin-si (KR)

(73) Assignee: HYUNDAI MOBIS Co., Ltd., Yongin-si (KR)

(21) Appl. No.: 14/922,722

(22) Filed: Oct. 26, 2015

(30) Foreign Application Priority Data
Nov. 17, 2014 (KR) 10-2014-0160176

(51) Int. Cl. H04N 5/235; H04N 5/357

(52) U.S. Cl. CPC H04N 5/2353; H04N 5/2357; H04N 5/357

(57) ABSTRACT

The present invention relates to a camera system for a vehicle and an operating method thereof and an exemplary embodiment of the present invention provides a camera system for a vehicle, including: a reception module which receives a country code number corresponding to a position of a vehicle, from a code supplying device; a sensor module which, when an optical signal corresponding to a surrounding environment of the vehicle is input, outputs an image signal corresponding to the optical signal; and a control module which, when the country code number is received, varies an exposure time (integration time) of the sensor module in accordance with a natural frequency which is set to correspond to the country code number and controls the sensor module to receive the optical signal during the exposure time.

### CROSS-REFERENCE TO RELATED APPLICATIONS

The present application claims priority to Korean Patent Application Number 10-2014-0160176 filed Nov. 17, 2014, the entire contents of which application is incorporated herein for all purposes by this reference.

### TECHNICAL FIELD

The present invention relates to a camera system for a vehicle and an operating method thereof, and more particularly, to a camera system for a vehicle which easily prevents image flickering which is generated in accordance with a natural frequency of an illumination apparatus depending on each country's standard and an operating method thereof.

### BACKGROUND

Recently, a system which includes small size cameras provided at left, right, front and rear sides of the vehicle for driving safety to check left, right, front, and rear sides using images through a display of an instrument panel in front of a driver seat starts being applied to a vehicle technology. As the camera is actively utilized in the vehicle, a quality of an output image becomes an important yardstick for evaluating a performance of the camera. An image quality of a camera which is currently installed in the vehicle to be used is much lower than an image quality of an exclusive digital camera, due to problems of a circuit, such as a data compression technique, power consumption, or limited built-in memory and problems of a camera module, such as difficulty of optical zoom, usage of low band optical filter, a low level of color reproducibility, or limitation of resolution.

A quality of an image is significantly affected by a characteristic of a camera and a characteristic of an illumination apparatus. Therefore, in order to evaluate a quality of an image which is viewed by the driver, an image quality of a camera which is mounted in the vehicle needs to be evaluated first.

In order to evaluate the image quality of the camera, a standard chart and a standard illumination environment for evaluating an image quality of a camera which is defined by international organization for standardization need to be used. Under the standard illumination environment, a standard chart for evaluating a camera is photographed by a camera which is fixed to evaluate an image quality and the photographed image is analyzed to evaluate the image quality of the camera.

Recently, even though an image quality of the camera, that is, the image is measured under the standard illumination environment, studies to prevent image flickering which may be generated due to different natural frequencies of illumination apparatuses for every country are being performed.

### SUMMARY

The present invention has been made in an effort to provide a camera system for a vehicle which easily prevents image flickering which is generated in accordance with a natural frequency of an illumination apparatus for every country and an operating method thereof.

An exemplary embodiment of the present invention provides a camera system for a vehicle, including: a reception module which receives a country code number corresponding to a position of a vehicle, from a code supplying device; a sensor module which, when an optical signal corresponding to a surrounding environment of the vehicle is input, outputs an image signal corresponding to the optical signal; and a control module which, when the country code number is received, varies an exposure time (integration time) of the sensor module in accordance with a natural frequency which is set to correspond to the country code number and controls the sensor module to receive the optical signal during the exposure time.

The code supplying device may be at least one of an electronic control unit (ECU) which controls the vehicle and a navigation system which is provided in the vehicle.

The sensor module may include a sensor unit which converts the optical signal input when a diaphragm coupled to a main body of the sensor module is open into an electrical signal in accordance with control of the control module; and a signal processing unit which processes the electric signal to output the image signal corresponding to the surrounding environment.

The signal processing unit may remove noise included in the electric signal, convert the electric signal into a digital signal, and output the image signal in accordance with a level of the digital signal.

The control module may include a storing unit in which a plurality of natural frequencies corresponding to a plurality of country code numbers is stored; a time setting unit which, when the country code number is received, selects the natural frequency corresponding to the country code number, among the plurality of natural frequencies and sets an exposure time of the sensor module based on the natural frequency; and a control unit which controls the sensor module to receive the optical signal during the exposure time of the sensor module and controls the display module to display an image corresponding to the image signal.

The time setting unit may set the exposure time of the sensor module so as to correspond to an integral multiple of a periodic time for the natural frequency.

The sensor module may output an image signal corresponding to the optical signal when the diaphragm coupled to the main body of the sensor is open in accordance with the control of the control unit and the control unit may operate the diaphragm to be open so as to correspond to the exposure time of the sensor module.

Another exemplary embodiment of the present invention provides an operating method of a camera system for a vehicle, including: receiving a country code number corresponding to a position of a vehicle, from a code supplying device; setting an exposure time to correspond to the country code number, based on the stored natural frequency; and opening a diaphragm which is coupled to a main body of the sensor module so as to input an optical signal to a sensor module during the exposure time. Further, in the exposure time setting, the exposure time of the sensor module may be set so as to correspond to an integral multiple of a periodic time for the natural frequency.

The method may further include: receiving an image signal corresponding to the optical signal from the sensor module; and controlling a display module to display an image corresponding to the image signal.

The camera system for a vehicle according to the present invention and the operating method thereof may receive a code number for every country to vary exposing time of a sensor module in accordance with a natural frequency of an illumination apparatus corresponding to the code number for every country to prevent image flickering when an illumination apparatus, for example, a fluorescent lamp flickers, thereby improving an image quality of an image, that is, a camera.

### BRIEF DESCRIPTION OF THE DRAWINGS

FIG. 1 is a control block diagram illustrating a control configuration of a camera system for a vehicle according to an exemplary embodiment of the present invention.

FIG. 2 is a flowchart illustrating an operating method of a camera system for a vehicle according to an exemplary embodiment of the present invention.

### DETAILED DESCRIPTION OF THE INVENTION

Advantages and characteristics of the present invention and a method of achieving the advantages and characteristics will be clear by referring to exemplary embodiments described below in detail together with the accompanying drawings. However, the present invention is not limited to exemplary embodiments disclosed herein but will be implemented in various different forms. The exemplary embodiments are provided by way of example only so that a person of ordinary skilled in the art can fully understand the disclosures of the present invention and the scope of the present invention. Therefore, the present invention will be defined only by the scope of the appended claims. Like reference numerals indicate like elements throughout the specification.

Unless otherwise defined, all terms (including technical and scientific terms) used in the present specification may be used as the meaning which may be commonly understood by the person with ordinary skill in the art, to which the present invention pertains. It will be further understood that terms defined in commonly used dictionaries should not be interpreted to have an idealistic or excessively formalistic meaning unless expressly and specifically defined.

Hereinafter, an exemplary embodiment will be described in more detail with reference to drawings.

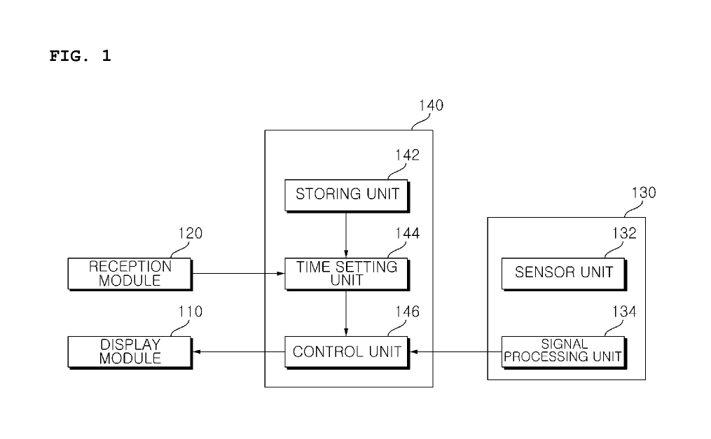

FIG. 1 is a control block diagram illustrating a control configuration of a camera system for a vehicle according to an exemplary embodiment of the present invention.

Referring to FIG. 1, a camera system for a vehicle may include a display module 110, a reception module 120, a sensor module 130, and a control module 140.

The display module 110 may display an image in accordance with control of the control module 140 and display an input menu through which a command to expand or reduce the image and other input command are input, but is not limited thereto.

The reception module 120 may receive a country code number from a code supplying device (not illustrated) mounted in the vehicle.

In the exemplary embodiment, the code supplying device may include at least one of an electronic control unit (not illustrated) which may control electronic apparatuses provided in the vehicle and a navigation, but is not limited thereto. The code supplying device may determine a position of the vehicle through a position information supplying source such as a GPS and supply a country code number corresponding to the determined position to the reception module 120.

For example, when the position of the vehicle is the United States, the code supplying device supplies a first country code number to the reception module 120 and when the position of the vehicle is Korea, the code supplying device supplies a second country code number to the reception module 120.

The reception module 120 performs CAN communication with the code supplying device to receive the country code number, for example, at least one of an area code and a country code, but is not limited thereto.

The sensor module 130 may include a sensor unit 132 and a signal processing unit 134.

When a diaphragm which is coupled to a main body of the sensor module 130 is open or closed and an optical signal corresponding to a surrounding environment of the vehicle is input, the sensor unit 132 may convert the optical signal into an electric signal corresponding to the optical signal, in accordance with the control of the control module 140.

That is, when the diaphragm is open, the sensor unit 132 converts the input optical signal into the corresponding electric signal and outputs the converted electric signal to the signal processing unit 134. For example, the sensor unit 132 may include a photoelectric converting element which converts light energy into electric energy.

The sensor unit 132 may include at least one CMOS sensor and the CMOS sensor may be an image sensor, but is not limited thereto.

When the electric signal is input, the signal processing unit 134 may remove a noise included in an analog electric signal and converts the analog electric signal into a digital signal and output an image signal in accordance with a level of the digital signal. Here, the level of the digital signal may refer to a RGB value which may be represented for every pixel which forms a screen of the display module 110.

In this case, the signal processing unit 134 may include at least one of a filter, an ADC, and a DSP, but is not limited thereto.

The control module 140 may include a storing unit 142, a time setting unit 144, and a control unit 146.

In the storing unit 142, a natural frequency for every country corresponding to each of the country code numbers may be stored. Here, the natural frequency may refer to a frequency of power. For example, a frequency of power which is used in an arbitrary country is 60 Hz, a natural frequency of the country may be stored as 60 Hz in the storing unit 142.

When the country code number is input from the reception module 120, the time setting unit 144 may select a natural frequency which has already set as a frequency corresponding to the country code number, among a plurality of natural frequencies which is stored in the storing unit 142 and set an exposure time (integration time) of the sensor module 130 to be changed from an initially set time, based on the natural frequency.

In this case, the time setting unit 144 may set the exposure time of the sensor module 130 so as to correspond to integral multiple of a periodic time for the natural frequency.

For example, when the natural frequency corresponding to the country code number is 50 Hz and a light source which is supplied with power of the natural frequency to output the optical signal is a fluorescent lamp, the fluorescent lamp may be turned on/off with a frequency of 100 Hz which is twice higher than the natural frequency. That is, the fluorescent lamp may flicker 100 times for one second. In this case, a time when the fluorescent lamp flickers one time is 10 ms, so that the time setting unit 144 may set the exposure time of the sensor module 130 to be 20 ms, 30 m, or the like, which corresponds to the integral multiple of 10 ms.

When the natural frequency corresponding to the country code number is 60 Hz and the light source is a fluorescent lamp, since the time when the fluorescent lamp flickers one time is 8.33 ms, the time setting unit 144 may set the exposure time of the sensor module 130 to be 16.66 ms, 24.99 m, or the like, which corresponds to the integral multiple of 8.33 ms.

When the light source flickers with the same interval as the natural frequency, the time setting unit 144 may set the time same as a period of the natural frequency as the exposure time of the sensor module 130.

That is, when an illumination apparatus which is provided on a road on which the vehicle runs or a parking space, for example, a fluorescent lamp flickers, the time setting unit 144 varies the exposure time of the sensor module 130 so as to correspond to a flickering interval in accordance with the flickering phenomenon, that is, the natural frequency, so that the flickering of the image which is displayed on the display module 110 may be reduced.

Thereafter, the time setting unit 144 sets the exposure time of the sensor module 130 to transmit the exposure time to the control unit 146.

The control unit 146 may open or close the diaphragm so as to correspond to the exposure time of the sensor module 130 which is input from the time setting unit 144.

Thereafter, the control unit 146 controls the display module 110 to display the image corresponding to the image signal output from the sensor module 130.

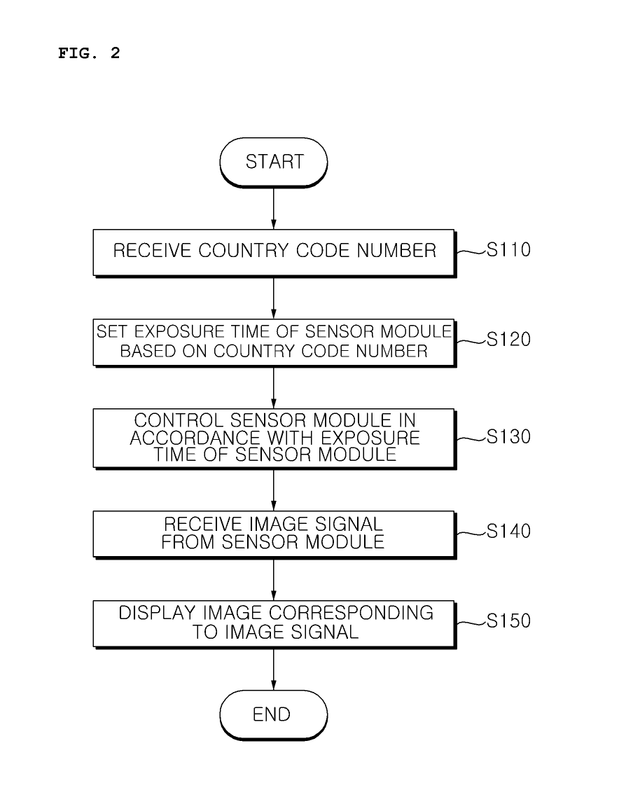

FIG. 2 is a flowchart illustrating an operating method of a camera system for a vehicle according to an exemplary embodiment of the present invention.

Referring to FIG. 2, the control module 140 of the camera system for a vehicle receives an arbitrary country code number from the code supplying device in step S110 and sets an exposure time of the sensor module 130 based on a set natural frequency corresponding to the country code number in step S120.

That is, when the country code number is input from the reception module 120, the control module 140 selects a natural frequency corresponding to the country code number, among a plurality of natural frequencies which is stored in the storing unit 142 and sets an exposure time (integration time) of the sensor module 130 to be changed from an initially set time, based on the natural frequency. The control module 140 may set the exposure time of the sensor module 130 so as to correspond to integral multiple of a periodic time for the natural frequency.

For example, when the natural frequency corresponding to the country code number is 50 Hz and the light source is a fluorescent lamp, since the time when the fluorescent lamp flickers one time is 10 ms, the control module 140 may set the exposure time of the sensor module 130 to be 20 ms, 30 ms, or the like, which corresponds to the integral multiple of 10 ms.

When the natural frequency corresponding to the country code number is 60 Hz and the light source is a fluorescent lamp, since the time when the fluorescent lamp flickers one time is 8.33 ms, the control module 140 may set the exposure time of the sensor module 130 to be 16.66 ms, 24.99 m, or the like, which corresponds to the integral multiple of 8.33 ms.

That is, when an illumination apparatus which is provided on a road on which the vehicle runs or a parking space, for example, a fluorescent lamp flickers, the control module 140 varies the exposure time of the sensor module 130 so as to correspond to a flickering interval in accordance with the flickering phenomenon, that is, the natural frequency.

After step S120, the control module 140 controls to open the diaphragm which is provided in the main body of the sensor module 130 during the exposure time of the sensor module 130 to input the optical signal to the sensor module 130 in step S130.

The control module 140 receives an image signal corresponding to the optical signal from the sensor module 130 in step S140 and controls the display module 110 to display an image corresponding to the image signal in step S150.

The word “comprise”, “configure”, or “have” used in the above description will be understood to imply the inclusion of stated elements unless explicitly described to the contrary, so that the word will be interpreted to imply the inclusion of other elements but not the exclusion of any other elements.

Exemplary embodiments of the present invention have been illustrated and described above, but the present invention is not limited to the above-described specific embodiments, it is obvious that various modifications may be made by those skilled in the art, to which the present invention pertains without departing from the gist of the present invention, which is claimed in the claims, and such modifications should not be individually understood from the technical spirit or prospect of the present invention.

What is claimed is:

1. A camera system for a vehicle, comprising:
a reception module which receives a country code number corresponding to a position of a vehicle, from a code supplying device;
a sensor module which, when an optical signal corresponding to a surrounding environment of the vehicle is input, outputs an image signal corresponding to the optical signal; and
a control module which, when the country code number is received, varies an exposure time (integration time) of the sensor module in accordance with a natural frequency which is set to correspond to the country code number and controls the sensor module to receive the optical signal during the exposure time.

2. The camera system of claim 1, wherein the code supplying device is at least one of an electronic control unit (ECU) which controls the vehicle and a navigation which is provided in the vehicle.

3. The camera system of claim 1, wherein the sensor module includes:
a sensor unit which converts the optical signal input when a diaphragm coupled to a main body of the sensor module is open into an electric signal in accordance with control of the control module; and
a signal processing unit which processes the electric signal to output the image signal corresponding to the surrounding environment.

4. The camera system of claim 3, wherein the signal processing unit removes a noise included in the electric signal, converts the electric signal into a digital signal, and outputs the image signal in accordance with a level of the digital signal.

5. The camera system of claim 1, wherein the control module includes:
a storing unit in which a plurality of natural frequencies corresponding to a plurality of country code numbers is stored;
a time setting unit which, when the country code number is received, selects the natural frequency corresponding to the country code number, among the plurality of natural frequencies and sets an exposure time of the sensor module based on the natural frequency; and
a control unit which controls the sensor module to receive the optical signal during the exposure time of the sensor module and controls the display module to display an image corresponding to the image signal.

6. The camera system of claim 5, wherein the time setting unit sets the exposure time of the sensor module so as to correspond to an integral multiple of a periodic time for the natural frequency.

7. The camera system of claim 5, wherein the sensor module outputs an image signal corresponding to the optical signal when the diaphragm coupled to the main body of the sensor module is open in accordance with the control of the control unit; and the control unit operates to the diaphragm to be open during the exposure time of the sensor module.

8. An operating method of a camera system for a vehicle, comprising:
receiving a country code number corresponding to a position of a vehicle, from a code supplying device;
setting an exposure time to correspond to the country code number, based on the stored natural frequency; and
opening a diaphragm which is coupled to a main body of the sensor module so as to input an optical signal to a sensor module during the exposure time.

9. The operating method of claim 8, wherein in the exposure time setting, the exposure time of the sensor module is set so as to correspond to an integral multiple of a periodic time for the natural frequency.

10. The operating method of claim 8, further comprising:
receiving an image signal corresponding to the optical signal from the sensor module; and
controlling a display module to display an image corresponding to the image signal.
